(19) United States
(12) Patent Application Publication
(10) Pub. No.: US 2025/0137366 A1
(43) Pub. Date: May 1, 2025

(54) METHOD TO ENHANCE WELL COMPLETION THROUGH OPTIMIZED FRACTURE DIVERSION

(71) Applicant: SCHLUMBERGER TECHNOLOGY CORPORATION, Sugar Land, TX (US)

(72) Inventor: Abdul Muqtadir KHAN, Stafford, TX (US)

(21) Appl. No.: 18/681,614

(22) PCT Filed: Aug. 4, 2022
(86) PCT No.: PCT/US2022/039391

§ 371 Date: Feb. 6, 2024

Related U.S. Application Data
(60) Provisional application No. 63/230,482, filed on Aug. 6, 2021.

(51) Int. Cl. E21B 43/27; C09K 8/72; E21B 47/06

(52) U.S. Cl. CPC E21B 43/27; C09K 8/72; E21B 47/06

(57) ABSTRACT

Methods of stimulating a hydrocarbon reservoir having carbonate components are described herein. An acid treatment material is developed by defining a diversion parameter as a ratio of volume of diversion material to be used for treatment of the reservoir to volume of fractures to be developed during acid treatment of the reservoir, defining a relationship between the diversion parameter and a diversion result, selecting a value of the diversion parameter based on the relationship, determining an amount of diversion material based on the selected value of the diversion parameter, and adding the amount of the diversion material to an acid treatment material. The reservoir is then subjected to acid treatment using the acid treatment material.

### CROSS-REFERENCE TO RELATED APPLICATIONS

This patent application claims benefit of U.S. Provisional Patent Application Ser. No. 63/230,482 filed Aug. 6, 2021, which is entirely incorporated herein by reference.

### FIELD

This patent application addresses stimulation of hydrocarbon reservoirs using diversion materials. Specifically, processes for designing diversion deployment in acid treatments are described herein.

### BACKGROUND

Hydrocarbon reservoirs are commonly stimulated to increase recovery of hydrocarbons. Hydraulic fracturing, where a fluid is pressurized into the reservoir at a pressure above the fracture strength of the reservoir, is commonly practiced. In most fracturing practice, a well is drilled into the formation and a casing formed on the outer wall of the well. The casing is then perforated using explosives to form holes in the casing that can extend a short distance into the formation from the well wall. Whether or not the well is cased and perforated, fluids can be deployed within the formation, using the well, to increase flow of hydrocarbons from the formation into the well. Particulates are often included with the fluids to influence how fracturing fluids enter different heterogeneous sections of a well to affect flow from the formation into the well, for example to reduce flow of water from the formation into the well, or to produce from multiple sections of the reservoir that have contrasting properties. Such methods are generally referred to as “diversion.”

In some cases, acidic fluids are deployed within the formation to increase the size of flow pathways within acid-susceptible materials of the formation by dissolving rock materials, such as carbonate rocks. This process is often called “rock etching.” Deploying diversion materials to a formation in the context of acid treatment is complicated by the fact that acid treatment changes the size and structure of flow pathways within the formation during and after deployment of the diversion materials. Rock material is continuously dissolved by acid, and chemical processes and reaction rates of the acid treatment continuously change. Currently, there is no robust method for planning and designing use of diversion materials with acid treatment. Determining how much particulate diversion material to use in a treatment fluid for a particular formation is effectively guesswork.

### SUMMARY

Embodiments described herein provide a method of treating a hydrocarbon reservoir having acid-susceptible components, the method comprising defining a diversion parameter as a ratio of volume of diversion material to be used for a reservoir treatment to volume of a perforation-fracture system to be developed during acid treatment of the reservoir; defining a relationship between the diversion parameter and a diversion result; selecting a value of the diversion parameter based on the relationship; determining an amount of diversion material based on the selected value of the diversion parameter; forming an acid treatment fluid comprising the amount of the diversion material; and applying the acid treatment fluid to the hydrocarbon reservoir.

Other embodiments described herein provide a method of forming a treatment fluid for a hydrocarbon reservoir having carbonate components, the method comprising defining a diversion parameter as a ratio of volume of diversion material to be used for a reservoir treatment to volume of a perforation-fracture system to be developed during acid treatment of the formation; defining a relationship between the diversion parameter and a diversion result; selecting a value of the diversion parameter based on the relationship; determining an amount of diversion material based on the selected value of the diversion parameter; selecting a particle size distribution of the diversion material based on a flow test; and adding the amount of the diversion material to an acid treatment material.

Other embodiments described herein provide a method of forming a treatment fluid for a hydrocarbon reservoir having carbonate components, the method comprising defining a diversion parameter as a ratio of volume of diversion material to be used for a reservoir treatment to volume of a perforation-fracture system to be developed during acid treatment of the formation; defining a relationship between the diversion parameter and a diversion result; selecting a value of the diversion parameter based on the relationship; multiplying the selected value of the diversion parameter and the volume of the perforation-fracture system to calculate a volume of diversion material; selecting a particle size distribution of the diversion material based on a flow test; and adding the amount of the diversion material to an acid treatment material.

### BRIEF DESCRIPTION OF THE DRAWINGS

FIG. 1 is a flow diagram summarizing a method according to one embodiment.

FIG. 2 is a graph showing the result of a bench slot test program for diversion materials.

FIG. 3 is a graph showing results of a fluid loss test using diversion materials.

FIG. 4 is a graph showing pressure development and pumping rate for a diversion test.

FIGS. 5A and 5B are geometric theory diagrams of a perforation tunnel.

FIG. 6 is a graph showing a simulated relationship between diversion parameter and pressure rise in formations having different characteristics.

FIGS. 7A-7D are illustrations of diversion performance in different scenarios.

### DETAILED DESCRIPTION

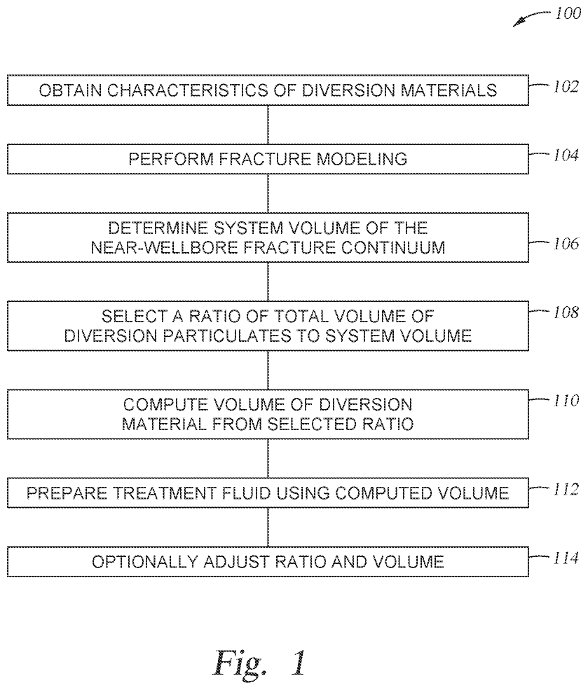

FIG. 1 is a flow diagram summarizing a method 100 according to one embodiment. The method 100 is a method of planning deployment of diversion materials with acid treatment of a hydrocarbon formation to result in successful change in the flow profile within the formation. The method 100 relies on a combination of formation modeling and diverter testing to achieve a treatment blend very likely to result in successful diversion within the formation.

At 102, characteristics of diversion materials are obtained to aid in selection of the diversion material for the treatment. One or more laboratory tests or yard-scale tests can be performed to give a baseline indication of the performance of one or more diversion materials and/or diversion blends under different flow conditions. The apparatus used for such testing is a flow apparatus with flow pathways having width, length, and or shape that simulates fractures that may exist, or may be expected to exist, within a formation of interest.

For example, a slot test can be performed in which a fluid material containing particulates is forced through a slot of selected dimension at different temperatures and pressure to establish flow conditions. Different types and concentrations of particulates can be compared with different carrier fluid properties to understand general effects of such parameters on fluid flow through constrained spaces. Diversion materials can then be selected based on the results and on comparison of the test conditions to expected formation characteristics. In general, a combination of particles of various sizes promotes effective bridging and plug stability with permeability low enough to provide proper isolation. Although not wishing to be limited by theory, it is believed that larger particles provide structural strength for particle bridges across gaps, and smaller particles occupy interstitial spaces between the larger particles to reduce permeability of the resulting plug.

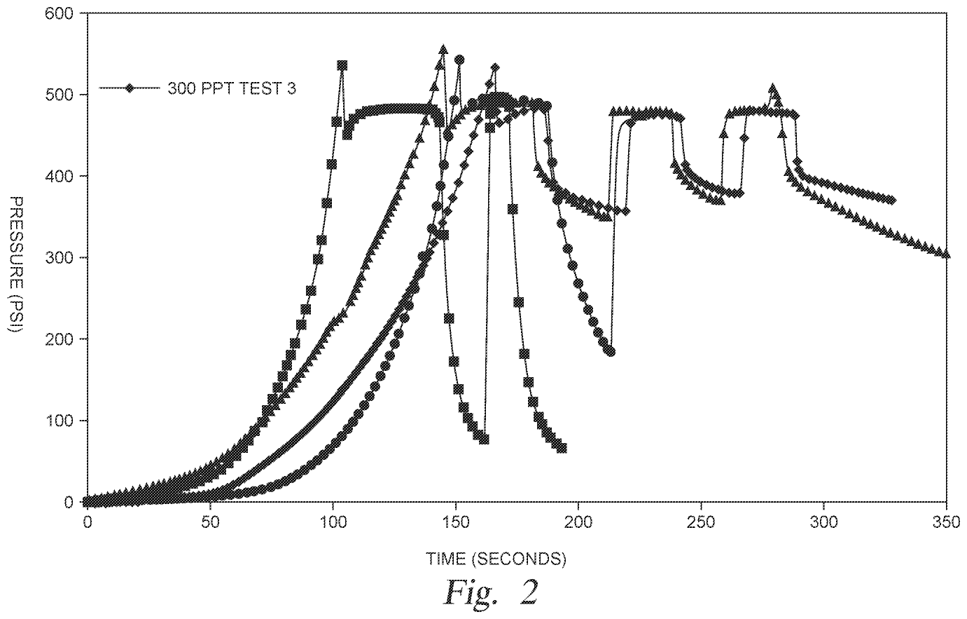

FIG. 2 is a graph showing the result of a bench scale slot test using slots of width from 0.14 inches to 0.6 inches. The diversion slurry was mixed in a 0.5 wt % solution of guar gum at concentrations of 300 ppt (Ibm/1,000 gal US) and 600 ppt, and was flowed in a 20 mm pipe through different sized slots. Pressure development of the system was monitored to assess basic ability of the diverter material to form a plug, and the permeability of the plug.

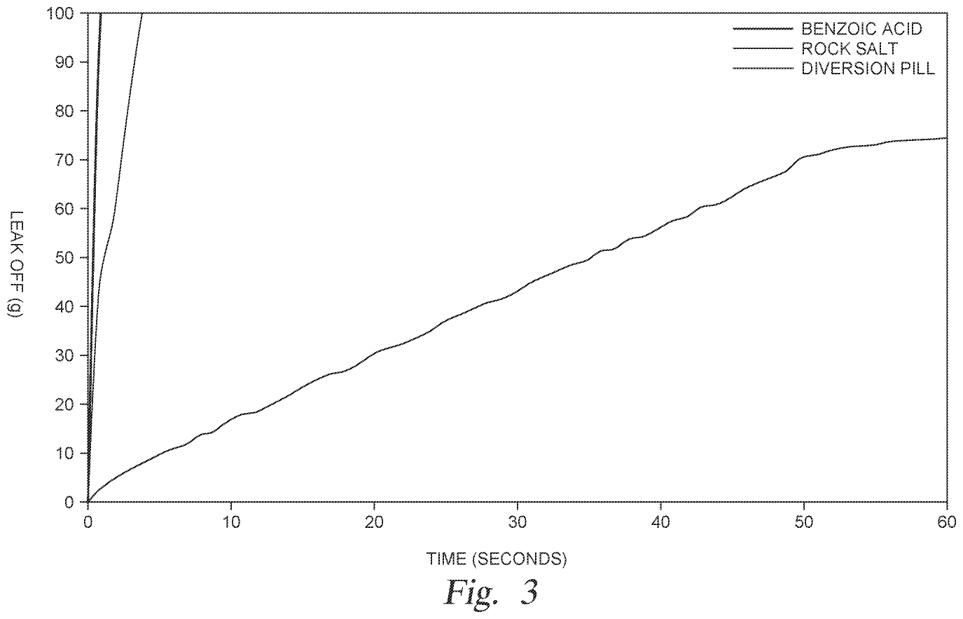

As another example, a pressurized fluid loss test can be performed, potentially for comparison to the slot test described above. A fluid loss cell can be fitted with a flow restriction insert, which can be a slotted insert like that used in the slot test above, a conical insert, or another useful insert. The insert typically has a plug of diversion material installed, for example by flowing a diversion slurry through the insert. In some cases, the insert used for the slot test can be transferred to the fluid loss cell for direct comparison. FIG. 3 is a graph showing results of a fluid loss test performed at room temperature and pressure of 1,300 psi. Conical inserts varying in minimum diameter from 0.1 inches to 0.9 inches were used, and fluid leakoff versus time plotted in the graph.

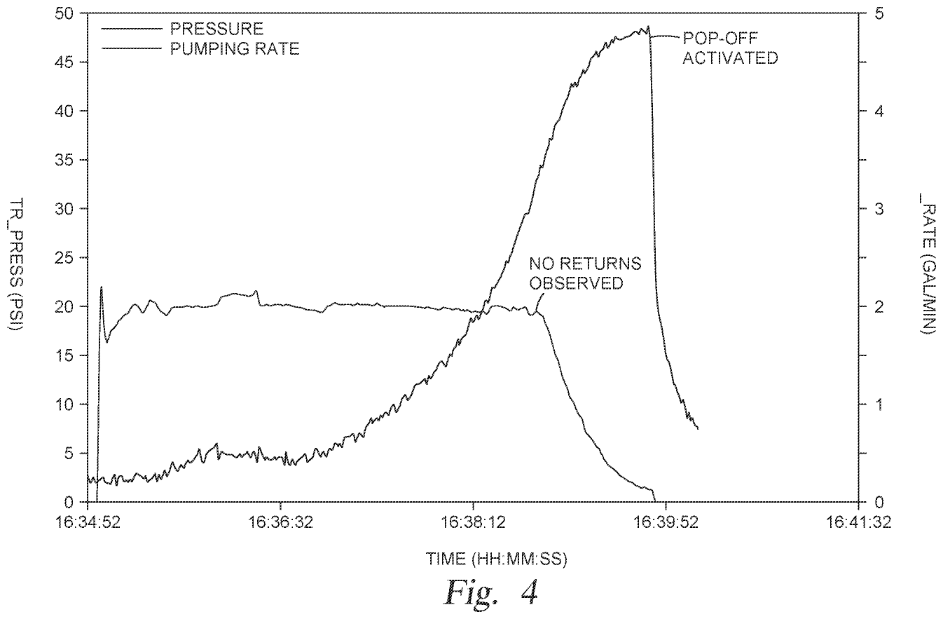

In an example of an intermediate-scale yard plugging test, a 350 gallon tank was used to supply water to a low-pressure low-flow pump through a two inch line. A four inch line delivered fluid from the pump to a cap fitted with an 8 mm tube to simulate flow into a fracture. Particulate material was blended into the four inch line to form the diversion slurry. A sensor was used to record pressure. In this test, pressure relief valves were used as safety measures. FIG. 4 is a graph showing pressure development and pumping rate for a test performed at a nominal pumping rate of 2 gal/min using particulate concentration of 150 ppt. A collection of tests were run at different flow rates and particulate concentrations to profile one diversion material. Data from the tests are shown in Table 1, below:

TABLE 1
Results of Yard Plugging Test

| | Particulate | Volume | | Particulate |
|---|---|---|---|---|
| Rate | Concentration | to Plug | ΔP | Mass |
| (gal/min) | (ppt) | (gal) | (psi) | (lbs) |
| 0.5 | 150 | 0.7 | 6 | 0.11 |
| 1 | 150 | 1 | 15 | 0.15 |
| 1.5 | 150 | 6 | 30 | 0.9 |
| 2 | 150 | 8 | 48 | 1.2 |
| 3 | 150 | No plugging | 10 | — |
| 1.5 | 75 | No plugging | 3 | — |
| 1.5 | 300 | 6 | 41 | 1.8 |

“Rate” is the rate at which the diversion mixture was pumped into the 8 mm tube. “Volume to Plug” is the total volume pumped before plugging of the 8 mm tube was detected by pressure rise. The total pressure rise observed is recorded in the column labelled “ΔP,” and the particulate mass participating in the plug was recorded in the “Particulate Mass” column. These data show that the particular diversion system, in the test flow geometry, has a critical rate, at which maximum pressure drop is developed and sustained, of 2 gpm. The data also display the possibility of an inflection point in particulate concentration at or around 150 ppt. Such data can be used to design treatment flow regimes for maximum plugging effectiveness of a diversion material.

The methods described herein rely on a parameter that is a ratio of total volume of diversion material to total open volume of the formation to be treated. In order to determine the denominator, the formation is modeled to yield an estimate of system volume. Where a cased hole is perforated and acid-treated, a high-fidelity acid fracturing simulator can generate realistic estimates of etch width contours to build a basic understanding of the near-wellbore fracture structure. Such simulators generally use, as input, rock composition, acid type and concentration, acid volume, and an initial fracture structure, such as pressure gradient or another parameter. Etched width and length at wellbore are generally output by such simulators. The etched width and length can be used to estimate system volume.

Referring again to FIG. 1, at 104, fracture modeling is performed to estimate fracture structure parameters near the wellbore. The fracture structure parameters may include fracture width and length. Where the well is cased and perforated, a simulator is initiated with perforation structure (holes per foot, etc.) and optionally perforation efficiency (which can be estimated from a step-down test, as is known in the art). Where the well is open, fracture structure parameters can be estimated using fracture analysis based on direct measurements, for example based on imaging.

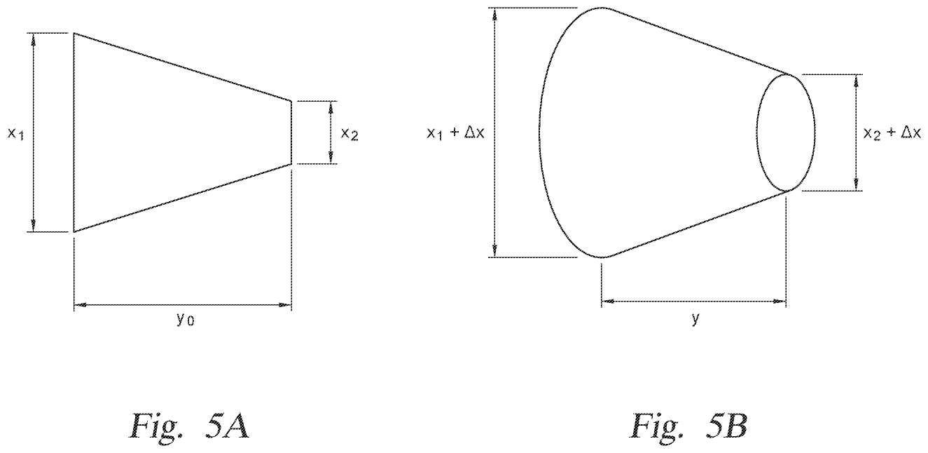

FIGS. 5A and 5B are geometric theory diagrams of a perforation-fracture system. The system is modeled as a collection of perforations into a wellbore along with one or more fractures emanating from each perforation. An open flow pathway of the perforation-fracture system is modeled as a frustum of a cone. The frustum has entrance diameter x₁, and end diameter x₂, with length y between entrance and end, as shown in FIG. 5A. In FIG. 5B, the acid etched perforation-fracture system is modeled. Entrance width after perforation is modeled as x₁+Δx and end width is modeled as x₂+Δx. Volume of the acid-treated perforation-fracture system is then given by the following equation:

$${V}_{system} = \frac{n π y}{12} [ {( {x}_{1} + Δ x )}^{2} + {( {x}_{2} + Δ x )}^{2} + ( {x}_{1} + Δ x ) ( {x}_{2} + Δ x ) ] ,$$

where n is the total number of perforations formed in the wellbore.

At 106, volume of the near-wellbore perforation-fracture continuum system is determined using the equation above. The geometric characteristics of the perforation-fracture system are applied to a geometric fracture model, and open volume of the perforation-fracture system is calculated. Commercially available perforation models can be used to estimate geometric characteristics such as perforation entrance diameter and perforation length. Commercially available acid fracture simulators can be used to estimate the change in width Δx of the perforation-fracture system and total length y under acid treatment conditions. The parameter x₂ can be initialized as 0 to model the end of the perforation-fracture system as infinitesimally small. The fracture efficiency can be applied to adjust the system volume for number of functional fractures.

At 108, a diversion parameter is used to determine an amount of diversion material to use. The diversion parameter is defined as a ratio of total volume of diversion particulates to total system volume, as follows:

$$β = \frac{{V}_{d}}{{V}_{system}} ,$$

where V_{d} is the total volume of the diversion material placed into the formation to accomplish the desired diversion, and V_{system} is the total void volume of the formation under treatment, determined as described at 106. The diversion parameter β essentially expresses how much of the void fraction of the system is filled with diversion material.

The calculation of 106 can be used as the total system volume, and the total volume of diversion material is the total volume of diversion material to be deployed into the formation. If a value is selected for the diversion parameter, and the total system volume is known, calculation of the volume of diversion material to use for a successful diversion is straightforward. The inventor has found that for tight carbonate formations, a diversion parameter of about 0.7 and about 0.8 can be expected to result in development of significant pressure rise in the formation, and therefore good diversion results. Higher diversion parameters generally yield better diversion, but at the cost of more diversion material used. Selecting an optimum diversion parameter ensures that enough diversion material is supplied to reduce spurt and to achieve bridging at the dimension of x₁+Δx of the perforation tunnel. A successful diversion can thus be performed without wasting diversion material and without causing treatment ballout or pressure-out.

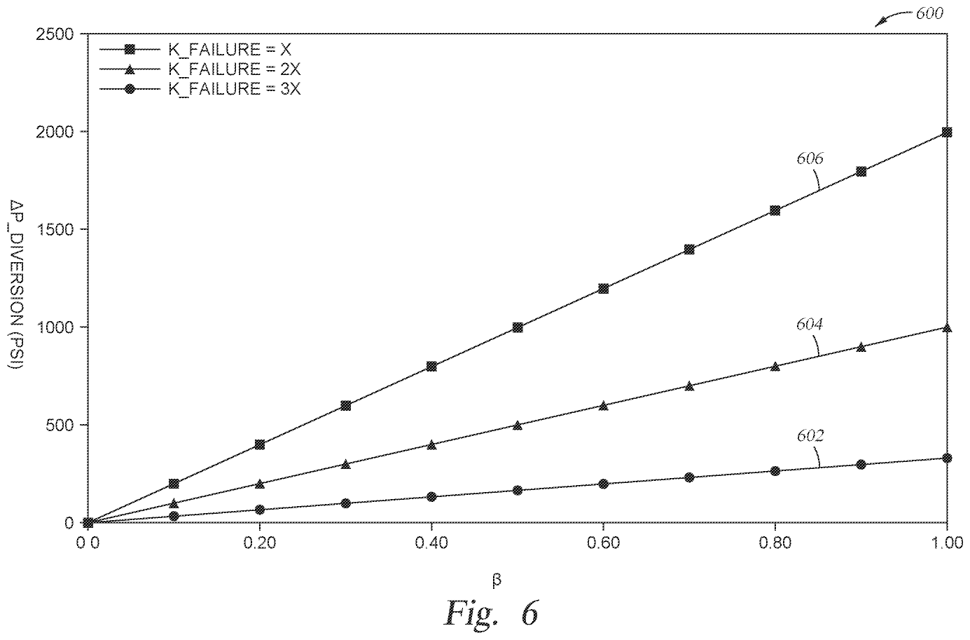

FIG. 6 is a graph 600 showing simulated results of diversion for different formation structure types. Diversion pressure is simulated as a function of the diversion parameter for three different structure types. The simulation is based on assumptions of fixed flow rate, viscosity, intake interval length, and skin, varying only failure mode permeability based on three failure modes. At 602, pressure rise is simulated based on formation permeability, assuming no plugs form in the formation. At 606, pressure rise is simulated based on diversion plug permeability, assuming the scenario where a plug forms in the perforation tunnel. At 604, pressure rise is simulated based on a combination of formation permeability and plug permeability for a scenario where some plugging of flow pathways occurs while other flow pathways remain unplugged.

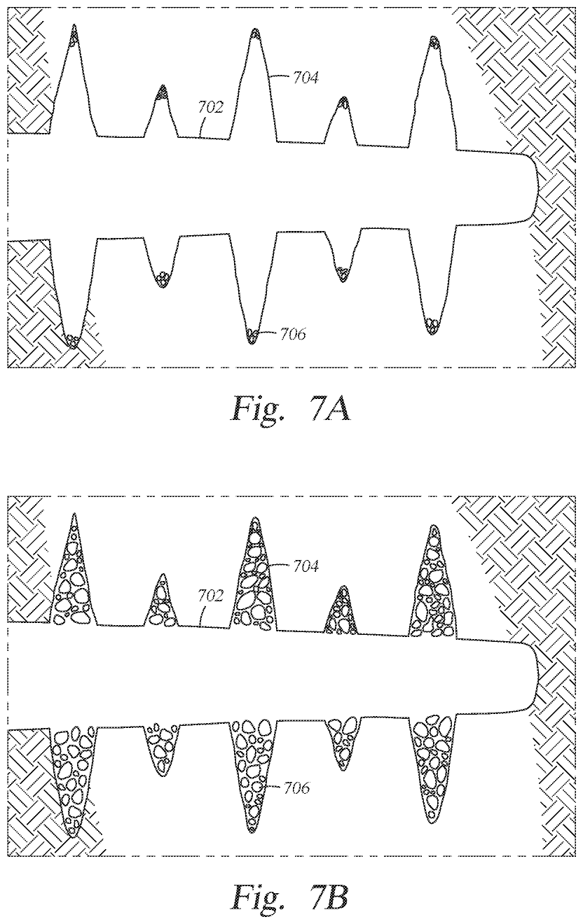

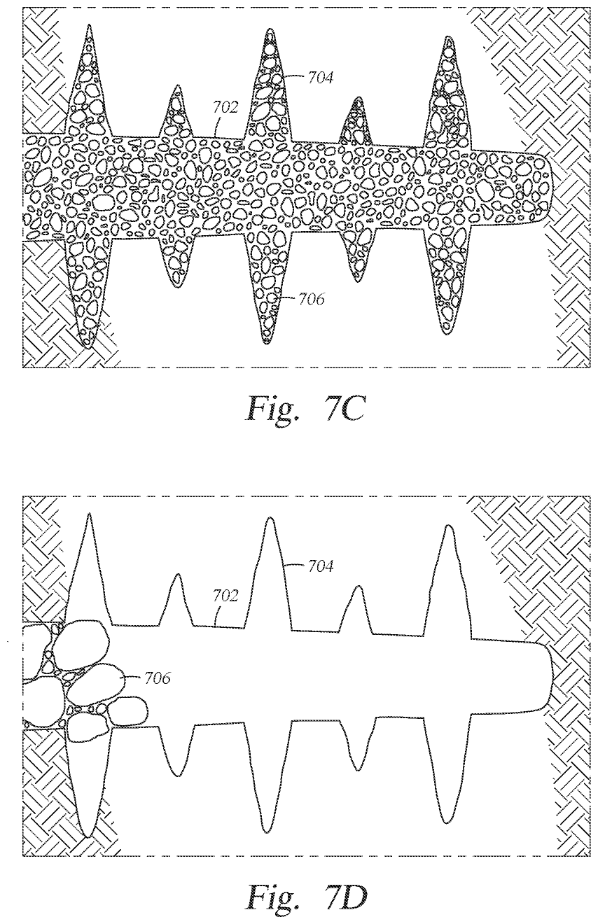

FIGS. 7A-7D are illustrations of diversion performance under different scenarios related to the relationships of 602, 604, and 606. The illustrations show various results of deploying a diversion material 706 through a perforation tunnel 702 into wormholes 704 extending from the perforation tunnel 702. FIG. 7A shows a diversion scenario where no plugs form and diversion material flows to the ends of passages within the formation. The particles of the diversion material are too small, or structurally too weak, to form a durable plug in the formation. The scenario of FIG. 7A is related to relationship 602. FIG. 7D shows a diversion scenario where diversion material does not flow into the formation, but forms a plug near the entrance of the perforation. In this scenario, the particles of the diversion material are too large to flow into the formation effectively. The scenario of FIG. 7D is related to relationship 606. FIG. 7B shows a diversion scenario where diversion material flows mostly to the ends of the perforation-fracture system, but some plugging occurs in the extremities. FIG. 7C shows a diversion scenario where diversion material plugs in the extremities and in the perforation of the perforation-fracture system. The scenarios of FIGS. 7B and 7C are related to the relationship 604, where pressure rise in the formation is supported by a combination of formation permeability and plug permeability. These scenarios illustrate the difficulty in successfully planning and executing diversion operations using conventional approaches.

It should be noted that the “optimum” diversion parameter may be different for different types of diversion materials and different types of formations. Computation of system volume recognizing the effects of acid treatment, as above, is generally applicable to acid-susceptible formations such as formations containing carbonate components.

Best results are generally obtained using a diversion material with a distribution of particle sizes to provide a low permeability plug at bridging.

At 110, a volume of diversion material is computed from the selected diversion parameter. The diversion parameter, multiplied by the system volume gives volume of diversion material to be used for the treatment. Multiplying the volume of diversion material by bulk density of the diversion material gives mass of diversion material to be dispersed into a treatment fluid for delivery to the formation.

At 112, the treatment fluid, having the volume of diversion material determined at 110, is pumped into the formation. Pressure development in the formation is monitored during pumping to determine performance of the diversion material. Pressure response can be compared to pressure response of the diversion material elucidated in the lab and yard tests to understand whether performance of the diversion material tracks results found in the tests.

At 114, the diversion parameter is optionally adjusted based on the observed pressure response. Where the diversion parameter is increased, more particulate material is added to the treatment fluid. Where the diversion parameter is decreased, more liquid (for example water) is added to the treatment fluid. In general, the inventor has found through experience with actual diversion field performance that a value of 0.7 to 0.8 for the diversion parameter β is effective for installing acid-containing diversion pills into formations having carbonate components. Where it is found that diversion performance from selecting a value in this range is unsatisfactory, the value can be adjusted for subsequent diversion pills based on pressure rise observed in the formation.

The method 100 can be used to target an initial volume of diversion material to use in an acid treatment stimulation operation. The diversion parameter described above can also be used to compare and categorize hydrocarbon formations, and to predict properties of those formations. The method 100 can also be used to improve design of diversion materials and treatment fluids for acid treatments of hydrocarbon reservoirs. Where initial pressure response is unexpected, parameters for computing system volume can be adjusted, and/or selection of the diversion parameter can be altered, or the basis for making the selection updated, for future diversion projects.

While the foregoing is directed to embodiments of the present invention, other and further embodiments of the present disclosure may be devised without departing from the basic scope thereof, and the scope thereof is determined by the claims that follow.

We claim:

1. A method of treating a hydrocarbon reservoir having acid-susceptible components, the method comprising:
defining a diversion parameter as a ratio of volume of diversion material to be used for a reservoir treatment to volume of a perforation-fracture system to be developed during acid treatment of the reservoir;
defining a relationship between the diversion parameter and a diversion result;
selecting a value of the diversion parameter based on the relationship;
determining an amount of diversion material based on the selected value of the diversion parameter;
forming an acid treatment fluid comprising the amount of the diversion material; and
applying the acid treatment fluid to the hydrocarbon reservoir.

2. The method of claim 1, wherein selecting a value of the diversion parameter comprises using a target value of 0.7 to 0.8 for the diversion parameter.

3. The method of claim 1, wherein determining an amount of diversion material comprises multiplying the selected value of the diversion parameter and the volume of the perforation-fracture system.

4. The method of claim 3, wherein the volume of perforation-fracture system is determined by ascertaining geometric characteristics of the perforation-fracture system and applying the geometric characteristics to a conical frustum model of the perforation-fracture system.

5. The method of claim 4, wherein the conical frustum model specifies a relationship of the volume of the perforation-fracture system to the geometric characteristics, as follows:
$${V}_{system} = \frac{n π y}{12} [ {( {x}_{1} + Δ x )}^{2} + {( {x}_{2} + Δ x )}^{2} + ( {x}_{1} + Δ x ) ( {x}_{2} + Δ x ) ] ,$$
wherein x₁ is entrance diameter of a perforation tunnel of the perforation-fracture system, x₂ is an end diameter of a fracture of the perforation-fracture system, y is a length of an open pathway of the perforation-fracture system, Δx is expected growth in width of the pathway during acid treatment, and n is number of perforations to be included in a single treatment.

6. The method of claim 3, further comprising selecting a particle size distribution of diversion material based on a flow test.

7. The method of claim 3, further comprising monitoring pressure rise during applying the acid treatment to the hydrocarbon reservoir and adjusting the value of the diversion material, based on the pressure rise, for subsequent treatments of the reservoir.

8. A method of forming a treatment fluid for a hydrocarbon reservoir having carbonate components, the method comprising:
defining a diversion parameter as a ratio of volume of diversion material to be used for a reservoir treatment to volume of a perforation-fracture system to be developed during acid treatment of the reservoir;
defining a relationship between the diversion parameter and a diversion result;
selecting a value of the diversion parameter based on the relationship;
determining an amount of diversion material based on the selected value of the diversion parameter;
selecting a particle size distribution of the diversion material based on a flow test; and
adding the amount of the diversion material to an acid treatment material.

9. The method of claim 8, wherein selecting a value of the diversion parameter comprises using a target value of 0.7 to 0.8 for the diversion parameter.

10. The method of claim 8, wherein determining an amount of diversion material comprises multiplying the selected value of the diversion parameter and the volume of the perforation-fracture system.

11. The method of claim 10, wherein the volume of perforation-fracture system is determined by ascertaining geometric characteristics of the perforation-fracture system and applying the geometric characteristics to a conical frustum model of the perforation-fracture system.

12. The method of claim 11, wherein the conical frustum model specifies a relationship of the volume of the perforation-fracture system to the geometric characteristics, as follows:
$${V}_{system} = \frac{n π y}{12} [ {( {x}_{1} + Δ x )}^{2} + {( {x}_{2} + Δ x )}^{2} + ( {x}_{1} + Δ x ) ( {x}_{2} + Δ x ) ] ,$$
wherein x₁ is entrance diameter of a perforation tunnel of the perforation-fracture system, x₂ is an end diameter of a fracture of the perforation-fracture system, y is a length of an open pathway of the perforation-fracture system, Δx is expected growth in width of the pathway during acid treatment, and n is number of perforations to be included in a single treatment.

13. The method of claim 10, further comprising selecting a particle size distribution of diversion material based on a flow test.

14. The method of claim 10, further comprising monitoring pressure rise during applying the acid treatment to the hydrocarbon reservoir and adjusting the value of the diversion material, based on the pressure rise, for subsequent treatments of the reservoir.

15. A method of forming a treatment fluid for a hydrocarbon reservoir having carbonate components, the method comprising:
defining a diversion parameter as a ratio of volume of diversion material to be used for a reservoir treatment to volume of a perforation-fracture system to be developed during acid treatment of the reservoir;
defining a relationship between the diversion parameter and a diversion result;
selecting a value of the diversion parameter based on the relationship;
multiplying the selected value of the diversion parameter and the volume of the perforation-fracture system to calculate a volume of diversion material;
selecting a particle size distribution of the diversion material based on a flow test; and
adding the volume of the diversion material to an acid treatment material.

16. The method of claim 15, wherein selecting a value of the diversion parameter comprises using a target value of 0.7 to 0.8 for the diversion parameter.

17. The method of claim 15, wherein the volume of perforation-fracture system is determined by ascertaining geometric characteristics of the perforation-fracture system and applying the geometric characteristics to a conical frustum model of the perforation-fracture system, given as follows:
$${V}_{system} = \frac{n π y}{12} [ {( {x}_{1} + Δ x )}^{2} + {( {x}_{2} + Δ x )}^{2} + ( {x}_{1} + Δ x ) ( {x}_{2} + Δ x ) ] ,$$
wherein x₁ is entrance diameter of a perforation tunnel of the perforation-fracture system, x₂ is an end diameter of a fracture of the perforation-fracture system, y is a length of an open pathway of the perforation-fracture system, Δx is expected growth in width of the pathway during acid treatment, and n is number of perforations to be included in a single treatment.

18. The method of claim 17, further comprising selecting a particle size distribution of diversion material based on a flow test.

19. The method of claim 15, further comprising monitoring pressure rise during applying the acid treatment to the hydrocarbon reservoir and adjusting the value of the diversion material, based on the pressure rise, for subsequent treatments of the reservoir.

20. The method of claim 18, wherein the flow test comprises a slot test, a fluid loss test, and a yard plugging test.
